(19) United States
(12) Patent Application Publication
(10) Pub. No.: US 2021/0116033 A1
(43) Pub. Date: Apr. 22, 2021

(54) FLOATING RING SEAL

(71) Applicant: EagleBurgmann Germany GmbH & Co. KG, Wolfratshausen (DE)

(72) Inventor: Robert Imhauser, Koln (DE)

(73) Assignee: EagleBurgmann Germany GmbH & Co. KG, Wolfratshausen (DE)

(21) Appl. No.: 17/048,015

(22) PCT Filed: Mar. 25, 2019
(86) PCT No.: PCT/EP2019/057444

§ 371 Date: Oct. 15, 2020

(30) Foreign Application Priority Data
Apr. 19, 2018 (DE) 10 2018 205 979.9

(51) Int. Cl. F16J 15/44

(52) U.S. Cl. CPC F16J 15/441

(57) ABSTRACT

The invention relates to a floating ring seal for sealing on a rotating component, comprising: a sealing body (20), a seal ring carrier (6) retaining the sealing body (20), and a locking mechanism (7) arranged on the seal ring carrier (6) and adapted to retain the seal ring carrier (6) on a housing.

The invention relates to a floating ring seal for sealing on a rotating component, especially a rotating shaft, having significantly reduced weight and simplified locking mechanism against co-rotation of the floating ring seal with the rotating component.

Floating ring seals are known from prior art in various configurations. For example, floating ring seals are used to seal pump shafts in high speed pumps. The floating ring seals are in a floating arrangement on the shaft, allowing them to follow an appropriate radial deflection especially in the case of the shaft's radial deflection. An issue with floating ring seals is the permanent gap between the floating ring seal and the rotating component, where relatively strong leakage occurs. For this reason, several floating ring seals are usually arranged in series. However, this results in considerable constructional effort and, in particular, large installation space required in the axial direction of the component to be sealed, which increases the total installation length of the pump or the like, something that such pump manufacturers want to avoid as far as possible. Another problem with floating ring seals can reside in that during operation the floating ring seal co-rotates with the rotating shaft. However, this leads to increased wear, especially on the sides of the floating ring seal facing away from the shaft. Therefore, it would be desirable to avoid such wear.

It is therefore an object of the present invention to provide a floating ring seal for sealing on a rotating component having a simple and cost-saving structure, which floating ring seal is able to especially reduce an axial overall length of the seal and can prevent the floating ring seal from being co-rotated during operation. Furthermore, it is an object of the present invention to provide a component arrangement including a floating ring seal according to the invention.

This object will be solved by a floating ring seal having the features of claim 1 and a component arrangement having the features of claim 13. The respective subclaims show preferred embodiments of the invention.

In addition to easier assembly/disassembly, the floating ring seal according to the invention for sealing on a rotating component provides significant weight advantage. Furthermore, co-rotation of the floating ring seal during operation with a rotating component, especially a shaft on which the floating ring seal is sealing, can be avoided. According to the invention, this will be achieved in that the floating ring seal comprises a sealing body, which seals against the rotating component, and a seal ring carrier, which retains the sealing body. Furthermore, a locking mechanism is provided which is arranged on the seal ring carrier and is designed to retain the seal ring carrier on a housing or the like. The locking mechanism prevents the sealing ring carrier and the sealing body connected to the sealing ring carrier from co-rotating. A frictional connection can be provided between the sealing ring carrier and the sealing body, for example.

The locking mechanism for retaining the floating ring seal from co-rotation preferably comprises a bolt with a head. The head has a larger diameter than the bolt. This allows the locking mechanism to be provided very easy and cost-effective.

Preferably the bolt is fixed in the seal ring carrier. Fixing is preferably done using a threaded connection. This allows the bolt to be simply screwed into the seal ring carrier, the head protruding from the seal ring carrier and resting against abutting surfaces to prevent the floating ring seal from co-rotating.

It is especially preferred for the sealing body to be free of recesses. This prevents the sealing body from weakening, so that the dimensions and weight of the sealing body can significantly be reduced. As a result, the floating ring seal can be manufactured in a very compact and lightweight manner. Preferably, the sealing body is rectangular in cross-section without recesses, bores, holes, or the like.

Further preferably, the floating ring seal comprises a housing with a recess for floating accommodation of the sealing body and the seal ring carrier. Preferably, the recess is formed with a lateral notch to accommodate the locking mechanism. Thus, one portion of the locking mechanism protrudes into the lateral notch in the recess and the other portion of the locking mechanism is located on the seal ring carrier and is firmly connected thereto.

The lateral notch in the recess is preferably a longitudinal groove or a cylindrical recess having a diameter larger than any dimension of the locking mechanism. This ensures that the floating ring seal is enabled to follow radial shaft movements despite of the locking mechanism protruding into the lateral notch. Such radial deflections of the shaft may be caused by various reasons during operation. If the floating ring seal were not able to follow such radial shaft movements, it would result in direct contact and, during operation, high wear of the sealing body.

Further preferably, the floating ring seal comprises a one-piece sealing body having a first and a second throttling area directed radially inward. The throttling areas are separated from each other by a first circumferential groove on the inner circumference of the sealing body. The groove is located between the first and second throttling area. The design of a sealing body comprising two throttling areas, wherein each of which is directed towards the rotating component, and having a throttling gap between the rotating component and the two throttling areas, results in significant weight advantage as compared to two individual prior art floating ring seals. In comparison to two individual floating ring seals, the total mass of the floating ring seal according to the invention can be reduced by approx. 40%.

Preferably, a width of the first throttling area in the axial direction of the floating ring seal is smaller or equal to a second width of the throttling area in the axial direction of the floating ring seal. This increases the throttling effect of the second throttling area, reducing overall leakage of the floating ring seal.

Another great advantage of the arrangement according to the invention having two throttling areas with a groove arranged in between resides in that a leakage flow, which flows across the first throttling area towards the second throttling area, is slowed down in the groove, so that the leakage will subsequently be significantly reduced across the second throttling area. Herein, the leakage flow can especially form a counter flow.

Especially preferred is a groove width which is smaller than or equal to the first width of the first throttling area and/or which is smaller than or equal to the second width of the second throttling area.

According to another preferred embodiment of the invention, the one-piece sealing body further comprises a third throttling area directed radially inward. The third throttling area is arranged in series to the second throttling area. Furthermore, a second circumferential groove is arranged between the second and third throttling areas on an inner circumference of the sealing body.

Further preferably, the one-piece sealing body preferably includes a fourth throttling area. A third circumferential groove is formed between the third and fourth throttling area on the inner circumference of the one-piece sealing body. Thus, such a floating ring seal comprises four throttling areas and three circumferential grooves.

It is particularly preferred for the one-piece sealing body to be a carbon sealing, thereby achieving significant cost reduction.

Furthermore, the present invention relates to a component arrangement comprising a floating ring seal according to the invention as well as a rotating component, especially a shaft. Especially preferably, the shaft is a pump shaft or a compressor shaft.

The component arrangement comprises a first throttling gap between the first throttling area of the one-piece sealing body of the floating ring seal and the rotating component as well as a second throttling gap between the second throttling area of the one-piece sealing body and the rotating component. Further preferably, the throttling areas and the surface of the rotating component are designed such that a gap height of the first throttling gap and/or the second throttling gap remains constant in axial direction. Preferably, a gap height of the first throttling gap is the same as a gap height of the second throttling gap.

Preferably, the component arrangement is a pump or a compressor or a turbine. The component arrangement is preferably operated at very high speeds.

In the following, preferred example embodiments of component arrangements comprising floating ring seals are described in detail, while reference will be made to the accompanying drawing, wherein:

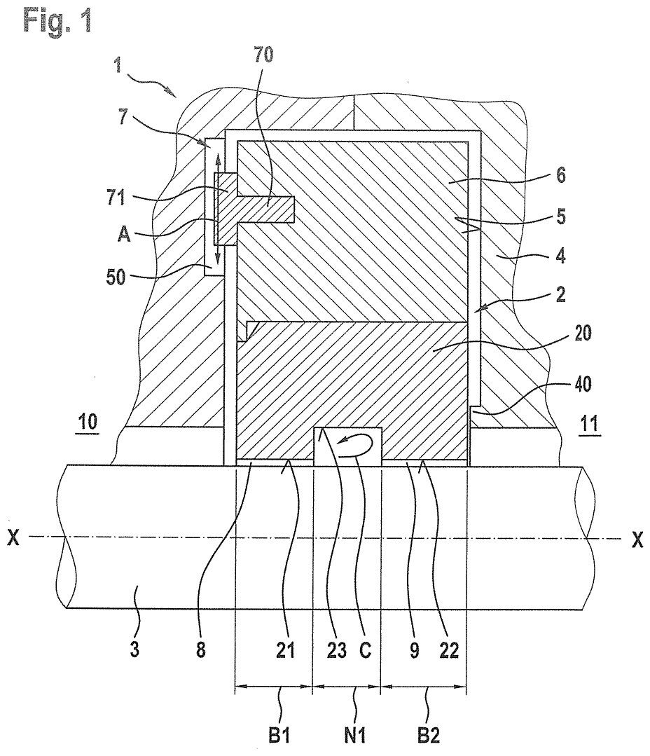

FIG. 1 is a schematic sectional view of a component arrangement comprising a floating ring seal, according to a first example embodiment of the invention,

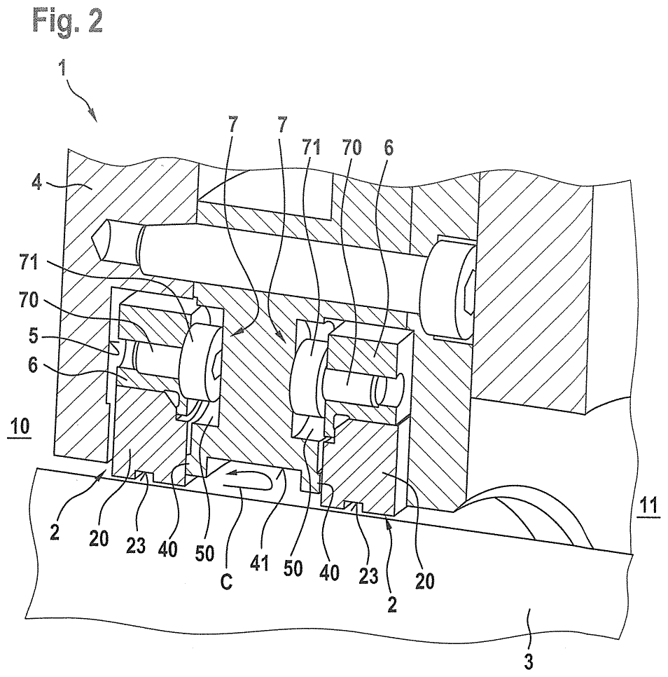

FIG. 2 is a schematic, perspective view of a component arrangement comprising a floating ring seal, according to a second example embodiment of the invention, and

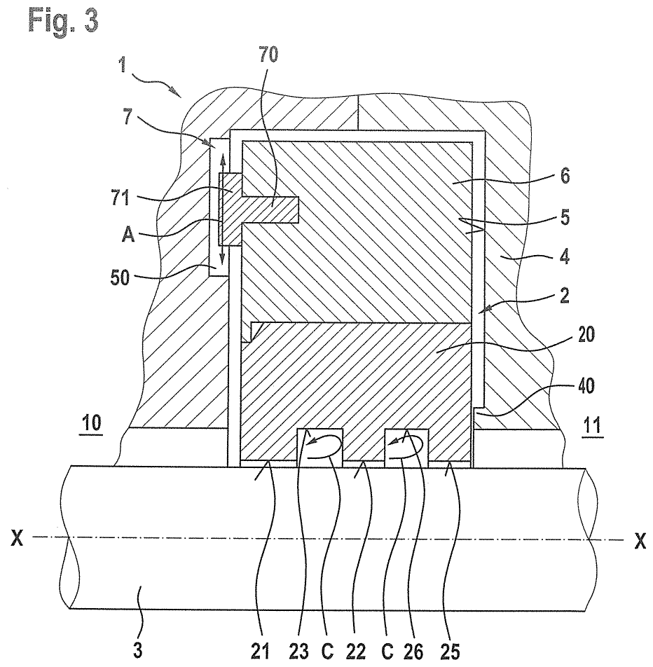

FIG. 3 is a schematic, perspective view of a component arrangement comprising a floating ring seal according to a third example embodiment of the invention.

Referring now to FIG. 1, a component arrangement 1 comprising a floating ring seal 2 will be described in detail below, according to a first example embodiment of the invention.

As can be seen from FIG. 1, the floating ring seal 2 comprises a one-piece sealing body 20 and a seal ring carrier 6. The seal ring carrier 6 is adapted to retain the one-piece sealing body 20. A frictional connection will preferably be provided between the seal ring carrier 6 and the sealing body 20.

The one-piece sealing body 20 comprises a first throttling area 21 and a second throttling area 22. The first throttling area 21 is located at a radially inward directed region of the one-piece sealing body 20. The second throttling area 22 is also located on the radially inward directed region of the one-piece sealing body 20.

As can be seen from FIG. 1, the floating ring seal 2 seals a product region 10 from an atmosphere region 11 on a shaft 3. A first throttling gap 8 is formed between the first throttling area 21 and a surface of the shaft 3, and a second throttling gap 9 is formed between the second throttling area 22 and the surface of the shaft 3.

A groove 23 is arranged between the first throttling area 21 and the second throttling area 22 in the axial direction X-X of the floating ring seal 2. The groove 23 is provided throughout around the inner circumference of the one-piece sealing body 20.

A first width B1 of the first throttling area 21 in axial direction X-X is smaller than a second width B2 of the second throttling area 22. Furthermore, a width N1 of the groove 23 in axial direction X-X is smaller than the first width B1 and the second width B2.

A first gap height at the first throttling gap 8 remains constant in axial direction X-X. A second gap height at the second throttling gap 9 in axial direction is also constant. The gap heights of the first and second throttling gaps are preferably selected such that the second gap height at the second throttling gap 9 is the same as the first gap height at the first throttling gap 8.

The floating ring seal 2 is located in a recess 5 in a housing 4. The housing 4 has a multiple part design to allow assembly in the axial direction of the shaft 3. As can be seen from FIG. 1, the floating ring seal 2 is arranged in a floating manner in recess 5. This enables the floating ring seal 2 to follow the shaft movement in case of radial deflections of the shaft 3, which may occur during operation. In this case, the radial shaft movement may cause a short contact between the shaft 3 and the one-piece sealing body 20.

The floating ring seal 2 also includes a locking mechanism 7 to allow it to be mounted in the body 4. The locking mechanism 7 comprises a bolt 70 with a head 71. As can be seen from FIG. 1, the bolt 70 is located in the seal ring carrier 6. The head 71 protrudes in axial direction X-X and is located in a lateral notch 50 in the recess 5. In the lateral notch 50, a radial clearance is provided for the head 71 such that the floating ring seal 2 is enabled to follow the radial deflections of the shaft described above. This is indicated by the double arrow A.

Preferably, the lateral notch 50 is a radial groove. Alternatively, the lateral notch 50 is a cylindrical recess having a larger diameter than a diameter of the head 71 of the locking mechanism 7. The larger diameter of the cylindrical recess than the head 71 allows the floating ring seal 2 to move slightly in the circumferential direction relative to the housing 4 in order to reduce loads on the locking mechanism 7 during relative movement between the floating ring seal and the housing 4.

In order to enable the floating ring seal 2 to be guided in the case of the radial deflections described above, a projection 40 is formed on the housing 4, projecting in the axial direction X-X. This allows the floating ring seal to be guided safely in the recess 5. The projection 40 also prevents the medium from bypassing the throttling gaps 8, 9 via a path behind the floating ring seal 2.

The projection 40 is provided so as to be completely circumferential in circumferential direction.

Thus, the floating ring seal 2, which is in accordance with the invention, can prevent the floating ring seal 2 from co-rotating with the rotating shaft 3. The locking mechanism 7 is very simple and inexpensive due to the design of a bolt 70 with head 71. Since the locking mechanism 7 is located on the seal ring carrier 6 and the lateral notch 50 is formed in the housing, the seal ring carrier 6 can have a very small overall height in the radial direction. Thus, one dimension of the seal ring carrier 6 can be reduced, which also results in weight reduction.

Furthermore, the floating ring seal 2 of the invention, with its one-piece design of the sealing body 20, allows the two individual floating ring seals previously used in prior art to be replaced. In particular, a significant weight reduction of up to approx. 40% can be achieved. Furthermore, the one-piece design of the sealing body 20 allows much easier assembly and disassembly in case that the floating ring seal 2 has to be replaced. Since the locking mechanism 7 is still provided exclusively in the seal carrier 6, the one-piece sealing body 20 of the floating ring seal can be designed while weakening recesses, grooves or the like used to accommodate a locking mechanism being omitted. This further reduces the weight of the sealing body 20, significantly extending the service life of the one-piece sealing body 20.

During operation, some leakage occurs through the first throttling gap 8, but the provision of the circumferential groove 23 significantly slows down the leakage flow velocity in the region of the groove 23. Thus, another leakage through the second throttling gap 9 towards the atmosphere region 11 is again significantly reduced or can be completely avoided if necessary.

A depth of the groove 23 is selected such that in the region of the groove 23 at least partial return flow C of the leakage, which has reached the groove 23 through the first throttling gap 8, occurs. This in addition reduces flow velocity of the leakage through the floating ring seal and minimizes further leakage through the second throttling gap 9.

FIG. 2 shows a component arrangement 1 according to a second embodiment of the invention, wherein equal or operationally equal parts are designated by the same reference numbers.

As can be seen from FIG. 2, the component arrangement 1 comprises two separate floating ring seals 2 according to the invention. The basic structure of the floating ring seals 2 is the same as in the first example embodiment. However, as can be seen from FIG. 2, the floating ring seals 2 are arranged mirror-inverted to each other on the shaft 3. Thus, a total of four throttling gaps are provided in the direction from the product region 10 to the atmosphere region 11. Furthermore, as can be seen from FIG. 2, a circumferential groove 41 is provided in the housing 4 in the region between the first and second floating ring seals 2. In this circumferential groove 41, the leakage supplied through the first floating ring seal 2 accumulates and forms a return flow C and further reduces the leakage occurring through the second floating ring seal to the atmosphere region 11. Furthermore, each of the floating ring seals comprises a locking mechanism 7 in the form of a bolt 70 with head 71. As can be seen in FIG. 2, the locking mechanisms 7 of the two floating ring seals are also arranged mirror-inverted. This significantly simplifies the structure of the component arrangement of the second design example, as the two lateral notches 50 are each formed in the housing portion between the two floating ring seals.

FIG. 3 shows a component arrangement according to a third example embodiment of the invention. As can be seen from FIG. 3, the floating ring seal 2 of the third example embodiment comprises a third throttling area 25, including a first groove 23 provided between the first and second throttling areas 21, 22 and a second groove 26 provided between the second throttling area 22 and the third throttling area 25. As in the first example embodiment, the first groove 23 and the second groove 26 are designed to be completely circumferential. This provides a one-piece sealing body 20 comprising three throttling areas, thus further reducing leakage from the product region 10 to the atmosphere region 11. The locking mechanism 7 shown in FIG. 3 will be configured as set forth in the first example embodiment.

### LIST OF REFERENCE NUMBERS

1 component arrangement
2 floating ring seal
3 shaft
4 housing
5 recess
6 sealing ring carrier
7 locking device
8 first throttling gap
9 second throttling gap
10 product region
11 atmosphere region
20 one-piece sealing body
21 first throttling area
22 second throttling area
23 first groove
24 projection
25 third throttling area
26 second groove
40 projection
41 groove
50 lateral notch
70 bolt
71 head
A double arrow
B1 first width
B2 second width
C return flow
N1 groove width of the first groove 23
X-X Axial direction

1. A floating ring seal for sealing on a rotating component, comprising:
a sealing body,
a sealing ring carrier which retains the sealing body, and
a locking mechanism which is arranged on the sealing ring carrier and is adapted to retain the sealing ring carrier on a housing.

2. The floating ring seal according to claim 1, wherein the locking mechanism comprises a bolt with a head.

3. The floating ring seal according to claim 2, wherein the bolt is fixed in the seal ring carrier.

4. The floating ring seal according to claim 3, wherein the bolt is fixed in the seal ring carrier by means of a threaded connection.

5. The floating ring seal according to claim 1, further comprising a recess formed in the housing for accommodating the sealing body and the seal ring carrier in a floating manner.

6. The floating ring seal according to claim 5, wherein a lateral notch for accommodating the locking mechanism is formed in the recess.

7. The floating ring seal according to claim 6, wherein the lateral notch is a longitudinal groove or a cylindrical recess with a diameter which is larger than a dimension of the locking mechanism, in particular a diameter of the head of the locking mechanism.

8. The floating ring seal according to claim 1, wherein the sealing body is formed in one piece and comprises a first throttling area directed radially inward, a second throttling area directed radially inward and a first circumferential groove on the inner circumference, wherein the first groove is located between the first throttling area and the second throttling area in the axial direction of the floating ring seal.

9. The floating ring seal according to claim 8, wherein a first width of the first throttling area is smaller than or equal to a second width of the second throttling area.

10. The floating ring seal according to claim 9, wherein the first groove has a groove width which is smaller than or equal to the first width and which is smaller than or equal to the second width.

11. The floating ring seal according to claim 8, wherein the one-piece sealing body further comprises a third throttling area directed radially inward, wherein a second groove is located in the axial direction of the floating ring seal between the third throttling area and the second throttling area.

12. A component arrangement comprising at least one floating ring seal according to claim 1 and a rotating component.

13. The component arrangement according to claim 12, wherein a first gap height of a first throttling gap between the first throttling area and a surface of the rotating component remains constant and/or wherein a second gap height of a second throttling gap between the second throttling area and the surface of the rotating component remains constant.

14. The component arrangement according to claim 13, wherein the first gap height is the same as the second gap height.
